(19) United States
(12) Patent Application Publication
(10) Pub. No.: US 2010/0232357 A1
(43) Pub. Date: Sep. 16, 2010

(54) COMMUNICATION SYSTEM, COMMUNICATION DEVICE, AND COMMUNICATION METHOD

(75) Inventors: Mitsuru Kubota, Matsumoto-shi (JP); Koichiro Ota, Omachi-shi (JP); Kazuyoshi Kitabayashi, Shiojiri-shi (JP)

Correspondence Address: ADVANTEDGE LAW GROUP, LLC, 922 W. BAXTER DRIVE, SUITE 100, SOUTH JORDAN, UT, 84095, US

(73) Assignee: Seiko Epson Corporation, Tokyo (JP)

(21) Appl. No.: 12/720,826

(22) Filed: Mar. 10, 2010

(30) Foreign Application Priority Data
Mar. 11, 2009 (JP) 2009-058287

(51) Int. Cl. H04W 4/00

(52) U.S. Cl. 370/328

(57) ABSTRACT

A communication system which communicates data through communication between a first communication device and a second communication device having common network identification information, wherein a first communication device includes a first communication unit which communicates data to and from other communication device having the common network identification information, a first attachment unit to which a storage device is detachably attached, an issuing unit which obtains network identification information of other communication device and issues network identification information not coinciding with the network identification information of this communication device, and a writing unit which writes the network identification information issued by the issuing unit to the storage device attached to the first attachment unit.

### CROSS-REFERENCE

The present application claims priority from Japanese Patent Application No. 2009-058287 filed on Mar. 11, 2009, which is hereby incorporated by reference in its entirety.

### BACKGROUND

Connecting communication devices for providing wireless communication between each other requires complicated operation such as network setting. Thus, the connecting work is difficult for a beginner user and even for a user skilled in the connecting work who spends time to complete the work. For overcoming this problem, various technologies for facilitating the connecting work of wireless communication have been proposed.

For example, a method which stores setting information necessary for providing wireless communication (connection network name and use channel) in a memory of a specialized wireless LAN (local area network) card in advance has been proposed (see Japanese Patent Publication No. 2006-227797). According to this method, a computer reads setting information stored in the memory of the wireless LAN card when the wireless LAN card is inserted into the computer, and provides setting for wireless communication.

Moreover, a communication system called ad hoc connection (ad hoc mode) has been proposed as a type of wireless communication system. According to typical ad hoc connection, two communication devices having common wireless network name called SSID (service set identifier) are connected such that wireless communication with each other can be provided. Then, wireless network is established by ad hoc connection, and communication is provided by protocol such as TCP/IP. In the ad hoc connection, the user can easily connect wireless communication by setting the same SSID for the two communication devices.

When plural communication devices having the same SSID exist in the area of providing wireless communication between one and other communication devices, it is not known which communication device of the plural devices connects with the one communication device for wireless communication. Thus, when plural communication devices having the same SSID exist as in this case, connection between desired communication devices for providing wireless communication between one another is difficult for the user.

### SUMMARY

Various embodiments may provide a communication system, a communication device, and a communication method capable of easily connecting a communication device which provides communication by using common network identification information with other desired communication device.

According to at lease one embodiment of the disclosure, a communication system which communicates data through communication between communication devices having common network identification information includes a first communication device, and a second communication device. The first communication device includes: a first communication unit which communicates data to and from other communication device having the common network identification information; a first attachment unit to which a storage device is detachably attached; an issuing unit which obtains network identification information of other communication device and issues network identification information not coinciding with the network identification information of this communication device; and a writing unit which writes the network identification information issued by the issuing unit to the storage device attached to the first attachment unit. The second communication device includes: a second communication unit which communicates data to and from other communication device having the common network identification information; a second attachment unit to which a storage device is detachably attached; and a reading unit which reads the network identification information from the storage device attached to the second attachment unit. The first communication unit and the second communication unit communicate data to and from each other by using the network identification information issued by the issuing unit and by using the network identification information read by the reading unit, respectively.

It is preferable that the communication system has a structure wherein: the network identification information is set for the communication units in advance; a memory unit for storing the network identification information set in advance is further provided; and the communication units communicate data by using the network identification information stored in the memory unit after communicating data by using the network identification information issued by the issuing unit.

According to at least one embodiment of the disclosure, a communication device which communicates with other communication device having common network identification information to communicate data to and from the other communication device includes: an attachment unit to which a storage device is detachably attached; an issuing unit which obtains network identification information of other communication device and issues network identification information not coinciding with the network identification information of this communication device; a writing unit which writes the network identification information issued by the issuing unit to the storage device attached to the attachment unit such that the network identification information can be read from the storage device by other communication device; and a communication unit which communicates data to and from other communication device having network identification information common to the network identification information issued by the issuing unit.

According to at least one embodiment of the disclosure, a communication method performed by a communication device which communicates with other communication device having common network identification information to communicate data to and from the other communication device and includes an attachment unit to which a storage device is detachably attached includes: obtaining network identification information of other communication device and issuing network identification information not coinciding with the network identification information of this communication device by the communication device; writing the issued network identification information to the storage device attached to the attachment unit by the communication device such that the network identification information can be read from the storage device by other communication device; and communicating data to and from other communication device having network identification information common to the issued network identification information by the communication device.

According to these embodiments, the network identification information not coinciding with network identification information of other communication device is issued, and the issued network identification information is retained by the communication device and other desired communication device as common information via the storage device. Thus, the communication device providing communication using common network identification information can be easily connected with other desired communication device for communication between one another.

### BRIEF DESCRIPTION OF THE DRAWINGS

Non-limiting and non-exhaustive embodiments of the present disclosure will be described with reference to the accompanying drawings, wherein like reference numbers reference like elements.

FIG. 1 illustrates a system structure of a communication system.

FIG. 2 is a block diagram schematically showing a function structure of a projector.

FIG. 3 is a block diagram schematically showing a function structure of a USB memory.

FIG. 4 is a block diagram schematically showing a function structure of a computer.

FIG. 5 is a flowchart showing operation of a device producing SSID in the communication system.

### DESCRIPTION OF EMBODIMENTS

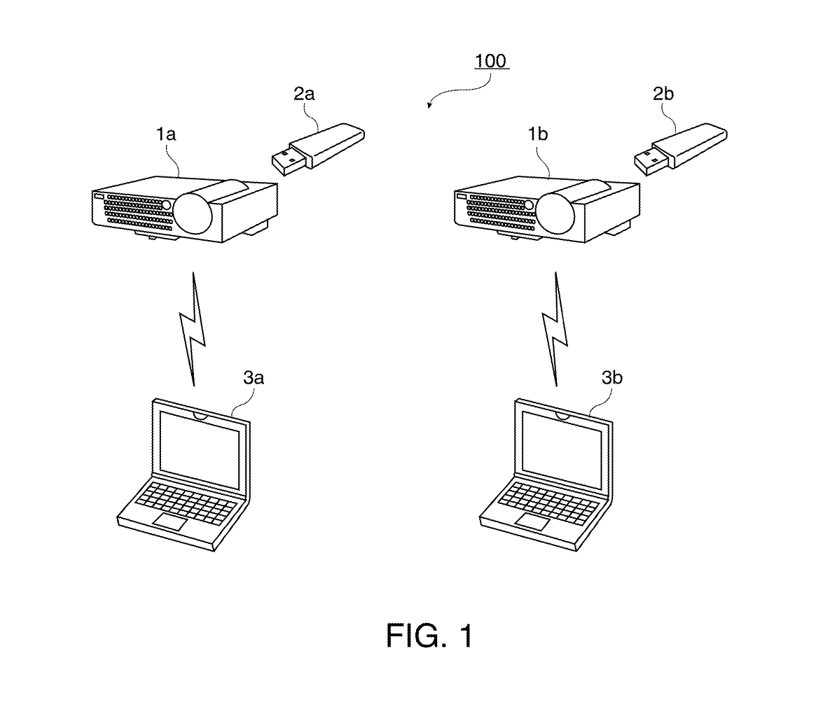

FIG. 1 illustrates a system structure of a communication system 100. The communication system 100 includes projector 1 (1a, 1b), a USB memory 2 (2a, 2b), and a computer 3 (3a, 3b). The projector la provides wireless communication with the computer 3a having common SSID by ad hoc connection. The projector 1b provides wireless communication with the computer 3b having common SSID by ad hoc connection. In this case, the same SSID is set for the projector 1a and the computer 3a, and for the projector 1b and the computer 3b, via USB memories 2a and 2b, respectively. The respective units included in the communication system 100, and operation for setting common SSID for the projector 1 and the computer 3 in the communication system 100 are hereinafter described.

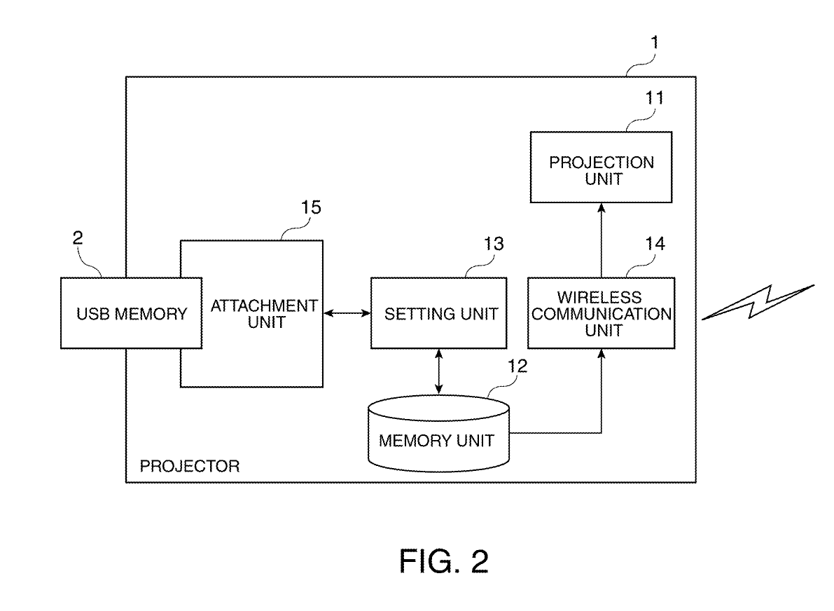

FIG. 2 is a block diagram schematically showing a function structure of the projector 1. The projector 1 includes a projection unit 11, a memory unit 12, a setting unit 13, a wireless communication unit 14, and an attachment unit 15.

The projection unit 11 projects an image supplied from the computer 3 on a screen by using light emitted from a light source lamp such as high-pressure mercury lamp and transmitted through a liquid crystal panel, for example.

The memory unit 12 is constituted by hard disk and semiconductor memory to store setting information necessary for providing wireless communication by the wireless communication unit 14. The setting information includes SSID (network identification information), projector name of the projector 1, MAC address, and other information. The memory unit 12 stores predetermined SSID beforehand.

The setting unit 13 is constituted by CPU (central processing unit) and dedicated hardware. When the predetermined USB memory 2 for network setting is connected with the attachment unit 15, the setting unit 13 issues SSID used when the projector 1 provides wireless communication with the other communication device (computer 3) by ad hoc connection and writes setting information to the memory unit 12 and the USB memory 2.

The wireless communication unit 14 provides wireless communication based on the setting information stored in the memory unit 12. For example, the wireless communication unit 14 reads SSID stored in the memory unit 12 and provides wireless communication with other communication device having the same SSID by ad hoc connection.

The attachment unit 15 is a unit to which USB connector is detachably connected to provide data communication with the USB memory 2.

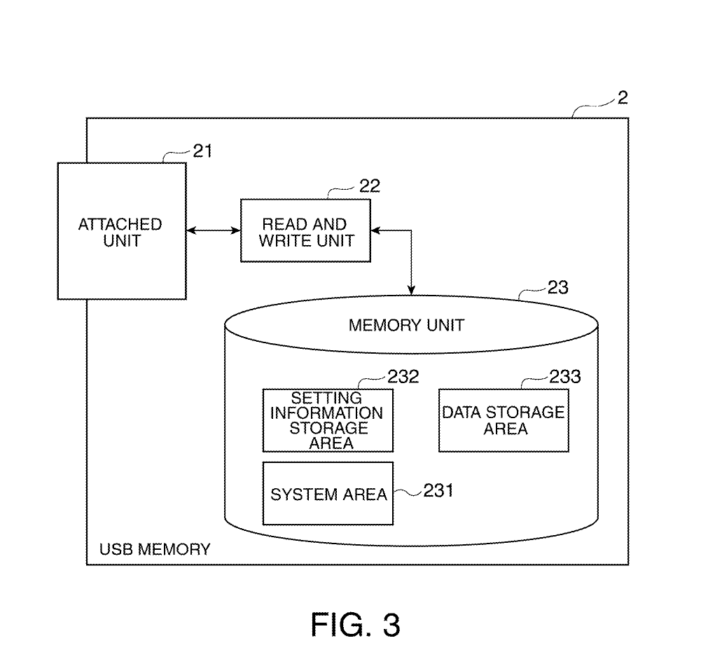

FIG. 3 is a block diagram schematically showing a function structure of the USB memory 2. The USB memory 2 includes an attached unit 21, a read and write unit 22, and a memory unit 23.

The attached unit 21 corresponds to a USB connector, and is inserted into the attachment unit 15 of the projector 1 or an attachment unit 31 of the computer 3 to provide data communication.

The read and write unit 22 is constituted by CPU, dedicated hardware and the like to read and write data from and to the memory unit 23. For example, when the USB memory 2 is connected with the projector 1, the read and write unit 22 receives SSID issued from the projector 1 via the attachment unit 15 and the attached unit 21 and writes the received SSID to the memory unit 23. When the USB memory 2 is connected with the computer 3, the read and write unit 22 reads SSID from the memory unit 23 and transmits the SSID to the computer 3 via the attached unit 21 and the attachment unit 31.

The memory unit 23 is constituted by semiconductor memory, and includes a system area 231, a setting information storage area 232, and a data storage area 233. The system area 231 stores data about predetermined USB memory for network setting. For example, the system area 231 stores “system” folder, and stores “GUID” folder in lower order. The setting information storage area 232 stores setting information such as SSID. The data storage area 233 stores various other data.

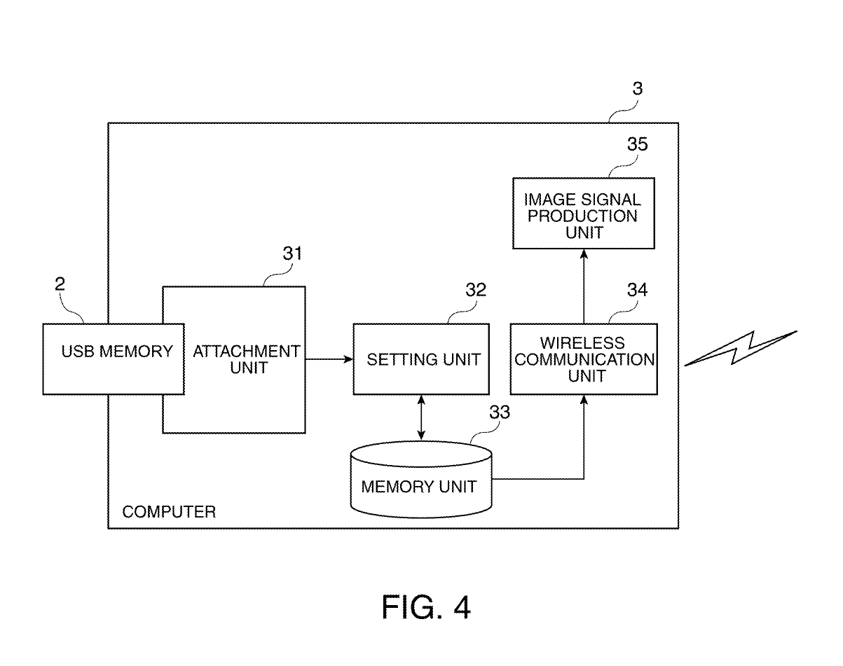

FIG. 4 is a block diagram schematically showing a function structure of the computer 3. The computer 3 includes the attachment unit 31, a setting unit 32, a memory unit 33, a wireless communication unit 34, and an image signal production unit 35.

The attachment unit 31 is a unit to which USB connector is detachably connected to provide data communication with the USB memory 2.

The setting unit 32 is constituted by CPU and dedicated hardware. When the predetermined USB memory 2 for network setting is connected with the attachment unit 15, the setting unit 32 reads setting information such as SSID from the USB memory 2 and writes the setting information to the memory unit 33.

The memory unit 33 is constituted by hard disk and semiconductor memory to store setting information written by the setting unit 32.

The wireless communication unit 34 reads the setting information stored in the memory unit 33 and provides wireless communication with the other communication device having the same SSID (projector 1) by ad hoc connection.

The image signal production unit 35 produces image signals to be transmitted to the projector 1, and outputs the image signals to the wireless communication unit 34.

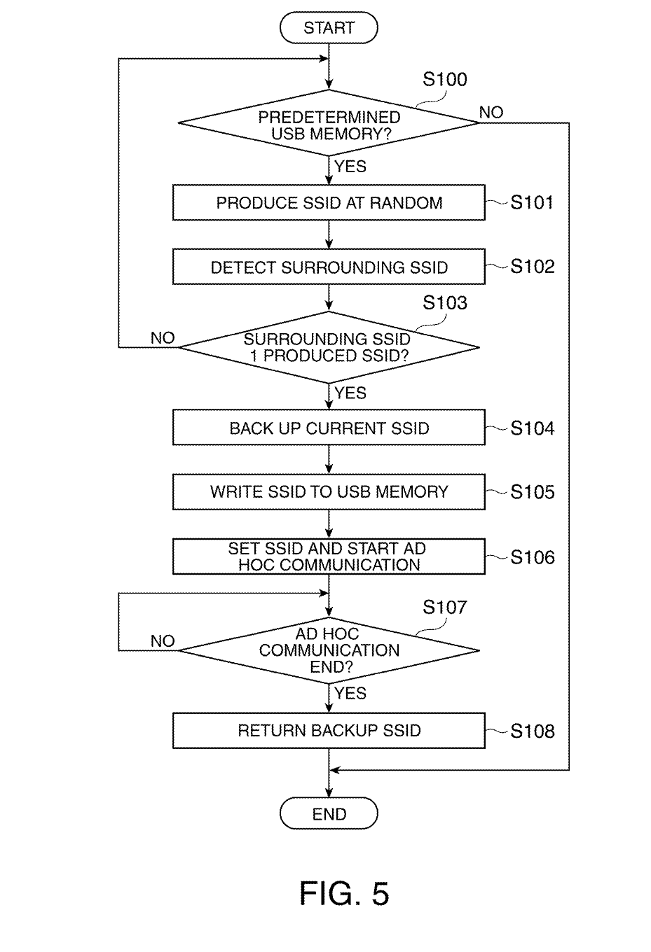

FIG. 5 is a flowchart showing operation of the projector 1, i.e., the device which issues SSID in the communication system 100. The operation of the projector 1 is now explained. Initially, the setting unit 13 determines whether the predetermined USB memory 2 is connected with the attachment unit 15 (step S100). More specifically, it is determined whether a particular folder structure exists in the USB memory 2. For example, when “system” folder exists in the system area 231 with “GUID” folder in the lower order, the setting unit 13 determines that the USB memory 2 connected with the attachment unit 15 is the predetermined USB memory for network setting. The setting unit 32 of the computer 3 also determines whether the predetermined USB memory 2 is connected by a process similar to that performed by the setting unit 13 of the projector 1.

When the connected USB memory is not the predetermined USB memory (step S100: NO), the process shown in FIG. 5 ends without issuing SSID. When the connected USB memory is the predetermined USB memory 2 (step S100: YES), the setting unit 13 produces SSID at random (step S101). Then, the wireless communication unit 14 detects SSID used by other communication devices surrounding the projector 1 for wireless communication (hereinafter referred to as “surrounding SSID”) (step S102). Subsequently, the setting unit 13 determines whether the SSID produced in step S101 (hereinafter referred to as “produced SSID”) agrees with the detected surrounding SSID (step S103). When at least one of the surrounding SSID agrees with the produced SSID (step S103: NO), the setting unit 13 abandons the produced SSID and repeats steps S101 and S102 until produced SSID not coinciding with any of the surrounding SSID can be obtained.

When produced SSID not coinciding with any of the surrounding SSID is obtained (step S103: YES), the setting unit 13 stores the SSID stored in the memory unit 12 in advance as SSID for backup in a memory area of the memory unit 12 different from the memory area storing the setting information (step S104). Then, the setting unit 13 writes the produced SSID to the USB memory 2 via the attachment unit 15 (step S105). Subsequently, the setting unit 13 writes the produced SSID to the memory area storing the setting information in the memory unit 12 to start ad hoc communication by using the SSID newly established by the wireless communication unit 14 (i.e., produced SSID) (step S106).

In case that the computer 3 having read the produced SSID from the USB memory 2 which retains the produced SSID written thereto has already started wireless communication by ad hoc connection using the produced SSID, the projector 1 and the computer 3 start wireless communication by ad hoc connection. When wireless communication by ad hoc connection ends (step S107: YES), the setting unit 13 deletes the SSID written to the memory area for storing the setting information in the memory unit 12 (i.e., produced SSID) in step S105, and reads the SSID stored for backup in step S104. Then, the setting unit 13 returns the setting information to the original information by writing the backed up SSID to the memory area for storing setting information in the memory unit 12 (step S108).

According to the communication system 100 having this structure, SSID not coinciding with SSID already used by other surrounding communication devices is produced by the setting unit 13 of the projector 1. Therefore, by using the SSID thus produced for the projector 1 and the computer 3, wireless communication can be easily provided between desired devices (projector 1 and computer 3 in this case) by ad hoc connection using SSID.

For setting common SSID for the projector 1 and the computer 3, it is only required for the user to insert the predetermined USB memory 2 for network setting to the projector 1 (device issuing SSID) and then insert the predetermined USB memory 2 to the computer 3 (device receiving SSID). Thus, the user can easily provide setting for network (particularly setting of SSID).

After the process in step S108, the SSID set for the projector 1 is returned to the original information. Thus, after finishing wireless communication with the computer 3 shown in FIG. 5, the projector 1 can initiate wireless communication using the SSID set in advance without rewriting SSID by the user.

### Modified Example

The communication system used for providing communication between the respective devices in the communication system 100 is not limited to the system using ad hoc connection. For example, in case of the communication system 100 containing access points in IEEE 802.11 series wireless LAN as communication devices, the projector 1 or the computer 3 may provide wireless communication with access points having common SSID. In this case, the access points in wireless LAN issue SSID in place of the projector 1 and write the issued SSID to the USB memory 2. Then, the projector 1 or the computer 3 reads the SSID from the USB memory 2 for wireless communication with the access points. In this case, the network identification information is not limited to SSID but may be network identification information corresponding to the system of communication applied to the communication system 100.

The devices included in the communication system 100 are not limited to the projector 1 and the computer 3 but may be any communication devices as long as they can provide wireless communication between one another having common network identifiers such as SSID. For example, the communication system 100 may include communication devices such as printer, cellular phone, PDA (personal digital assistants) as well as the projector 1 and the computer 3.

The storage device connected with plural communication devices in the communication system 100 is not limited to USB memory but may be any storage device as long as it can be detachably attached to the communication devices.

While the embodiments of the invention have been described in detail with reference to the drawings, particular structures and constitutions are not limited to those of the embodiment shown herein but may include other designs and the like without departing from the scope of the invention.

What is claimed is:

1. A communication system which communicates data through communication between communication devices having common network identification information, comprising:
a first communication device including
a first communication unit which communicates data to and from other communication device having the common network identification information,
a first attachment unit to which a storage device is detachably attached,
an issuing unit which obtains network identification information of other communication device and issues network identification information not coinciding with the network identification information of this communication device, and
a writing unit which writes the network identification information issued by the issuing unit to the storage device attached to the first attachment unit; and
a second communication device including
a second communication unit which communicates data to and from other communication device having the common network identification information,
a second attachment unit to which a storage device is detachably attached, and
a reading unit which reads the network identification information from the storage device attached to the second attachment unit,
wherein:
the first communication unit and the second communication unit communicate data to and from each other by using the network identification information issued by the issuing unit and by using the network identification information read by the reading unit, respectively.

2. The communication system according to claim 1, wherein:
the network identification information is set for the communication units in advance;
a memory unit for storing the network identification information set in advance is further provided; and
the communication units communicate data by using the network identification information stored in the memory unit after communicating data by using the network identification information issued by the issuing unit.

3. A communication device which communicates with other communication device having common network identification information to communicate data to and from the other communication device, comprising:
an attachment unit to which a storage device is detachably attached;
an issuing unit which obtains network identification information of other communication device and issues network identification information not coinciding with the network identification information of this communication device;
a writing unit which writes the network identification information issued by the issuing unit to the storage device attached to the attachment unit such that the network identification information can be read from the storage device by other communication device; and
a communication unit which communicates data to and from other communication device having network identification information common to the network identification information issued by the issuing unit.

4. A communication method performed by a communication device which communicates with other communication device having common network identification information to communicate data to and from the other communication device and includes an attachment unit to which a storage device is detachably attached, comprising:
obtaining network identification information of other communication device and issuing network identification information not coinciding with the network identification information of this communication device by the communication device;
writing the issued network identification information to the storage device attached to the attachment unit by the communication device such that the network identification information can be read from the storage device by other communication device; and
communicating data to and from other communication device having network identification information common to the issued network identification information by the communication device.
